(19) United States
(12) Patent Application Publication
(10) Pub. No.: US 2016/0128815 A1
(43) Pub. Date: May 12, 2016

(54) ORAL IRRIGATION SYSTEM

(71) Applicant: Rabinder K. Birdee, Walnut Creek, CA (US)

(72) Inventors: Rabinder K. Birdee, Walnut Creek, CA (US); Booker T. Pullen, Berkeley, CA (US); Calvin T. Jenkins, Berkeley, CA (US)

(21) Appl. No.: 14/538,143

(22) Filed: Nov. 11, 2014

(51) Int. Cl. A61C 17/02

(52) U.S. Cl. CPC A61C 17/0214; A61C 17/0202

(57) ABSTRACT

An oral irrigation system is disclosed. The oral irrigation system includes a spray head comprising a nozzle configured to generate a stream of liquid to clean the teeth or gum tissue of a user. A mounting structure is configured to mount the spray head to a sink or adjacent the sink to a counter to which the sink is mounted. An installation assembly is configured to mechanically and fluidly connect to a plumbing system of a building. The plumbing system supplies water to the sink by way of a first water supply line. The installation assembly is configured to direct a portion of the water from the first water supply line to the spray head. A hose provides fluid communication between the spray head and the installation assembly.

### BACKGROUND OF THE INVENTION

1. Field of the Invention

The present technology relates to oral irrigation technology and plumbing.

2. Description of the Related Art

Various types of water flossing devices and oral irrigator devices exist. Oral irrigating devices are designed to spray a fluid through an orifice that may be directed at one's mouth. The purpose is to use the stream of water to flush debris from between one's teeth. Many of these devices comprise a reservoir that contains the fluid. The devices are often plugged into the wall, as many of them contain an electrical pump used to force the fluid through the system.

Other water flossing devices attach to the faucet head of a bathroom sink, allowing the water pressure present in a house to direct the water through the orifice. Some oral irrigator devices are designed to be attached to a shower head so that a user may use the oral irrigator device while in the shower. However, a continuing need exists for improved water flossing devices and oral irrigators.

### SUMMARY

The systems, methods and devices described herein have innovative aspects, no single one of which is indispensable or solely responsible for their desirable attributes. Without limiting the scope of the claims, some of the advantageous features will now be summarized.

In one embodiment, an oral irrigation system is disclosed. The oral irrigation system can include a spray head comprising a nozzle configured to generate a stream of liquid to clean the teeth or gum tissue of a user. The spray head can be configured to mount to a sink or to a structure near the sink. An installation assembly can be configured to mechanically and fluidly connect to a plumbing system of a building. The plumbing system can supply water to the sink by way of a first water supply line. The installation assembly can be configured to direct a portion of the water from the first water supply line to the spray head. A hose can provide fluid communication between the spray head and the installation assembly.

In another embodiment, a method for providing a stream suitable for oral irrigation from a building water supply is disclosed. The method can include providing a spray head comprising a nozzle comprising configured to generate a stream of liquid to clean the teeth or gum tissue of a user. The method can further include mechanically and fluidly connecting an installation assembly to a first water supply line of a plumbing system of a building. The first water supply line can supply water to the sink. The installation assembly can be configured to direct a portion of the water from the first water supply line to the spray head. The method can include providing fluid communication between the spray head and the installation assembly.

In yet another embodiment, an oral irrigation system is disclosed. The oral irrigation system can include a spray head comprising a nozzle configured to generate a stream of liquid to clean the teeth or gum tissue of a user. A hole can be disposed through a sink or a structure near the sink. The hole can be sized and shaped to receive a portion of the spray head. An installation assembly can be connected to a plumbing system of a building. The plumbing system can supply water to the sink by way of a first water supply line. The installation assembly can be configured to direct a portion of the water from the first water supply line to the spray head. A hose can provide fluid communication between the spray head and the installation assembly. The hose can pass through the hole of the mounting structure.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting Like reference numbers and designations in the various drawings indicate like elements. Not all of the elements of the drawings are in to scale relate to other drawings and the comparative size of one element relative to another element in the drawings is not necessarily indicative of the relative sizes of the elements in one or more embodiments.

FIG. 1 is a schematic perspective view of an oral irrigation system including a spray head mounted to a counter near a sink.

FIG. 2 is a schematic system diagram of various components of the system shown in FIG. 1.

FIG. 3 is a schematic system diagram of the system shown in FIG. 1, according to another embodiment.

FIG. 4 is a schematic perspective view of a spray head, according to one embodiment.

FIG. 5 is a schematic perspective view of a spray head having multiple inlets, according to another embodiment.

### DETAILED DESCRIPTION

In the following detailed description, reference is made to the accompanying drawings, which form a part of the present disclosure. The illustrative embodiments are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structure and/or functionality in addition to or in place of one or more of the aspects set forth herein. Elements that are described as “connected,” “engaged,” “attached,” or similarly described, shall include being directly and/or indirectly connected, engaged, attached, etc. Alterations and further modifications of the inventive features illustrated herein, and additional applications of the principles of the inventions as illustrated herein, which would occur to one skilled in the art and having possession of this disclosure, are to be considered within the scope of the invention.

Descriptions of unnecessary parts or elements may be omitted for clarity and conciseness, and like reference numerals refer to similar elements throughout. In the drawings, the size and thickness of layers and regions may be exaggerated for clarity and convenience.

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description” one will understand how illustrated features serve to explain certain principles of the present disclosure.

Various embodiments disclosed herein relate to an oral irrigation system configured to assist in cleaning a user's teeth and/or gum tissue. For example, to maintain oral health, it can be important to thoroughly clean the spaces between teeth, as well as pockets in the gum tissue. Conventional techniques such as flossing with a piece of string may cause discomfort to the user and/or may not thoroughly clean deep pockets in the gums. Other devices, such as the water flossing devices made by Water Pik, Inc., of Fort Collins, Colo., direct water to the user's teeth to remove debris from the mouth. However, such devices typically include a countertop housing that is plugged into an electrical outlet to provide power to pump the water. Countertop devices may not be aesthetically pleasing to the user, as the housing and other components occupy space on the bathroom counter that clutters the bathroom (or other location where the user brushes his or her teeth). Furthermore, countertop devices typically use an electrical power source, either by a direct connection to a power outlet or by a connection between a battery charging station and the power outlet. Devices that use an independent electrical connection to the power outlet may be undesirable because they occupy electrical outlet(s) that may instead be used for other devices and/or because they increase the amount of electrical energy used by the system. Other devices may attach and/or detach from the outlet of the faucet of the sink or a shower that supplies water to the device. For such devices, the user may need to manually connect the cleaning device to the faucet or showerhead before each use and disconnect the device after use, which may complicate the cleaning process and inhibit usage. In addition, devices that attach and/or detach from the faucet or showerhead may also be aesthetically undesirable and/or may clutter the bathroom. The issues described above tend to hinder adoption of water flossing devices by consumers.

Accordingly, it can be desirable to provide an oral irrigation system that thoroughly cleans the user's teeth and/or gum tissue (including deep pockets) and that improves the user's experience relative to other cleaning devices. Advantageously, the embodiments disclosed herein can be used without using electrical power and by taking advantage of a building's plumbing system. For example, the embodiments disclosed herein can integrate the oral irrigation system with the plumbing system associated with a conventional sink. For example, the oral irrigation system disclosed herein can be mechanically and fluidly coupled to the pipes and other plumbing components that supply water to the sink in a building, such as sinks in the bathroom, kitchen, etc. The oral irrigation system can include a spray head in fluid communication with the sink's plumbing system by way of a hose. The spray head can include a nozzle configured to deliver a stream of liquid (e.g., water) to the user's mouth, where the stream is of a suitable size (e.g., diameter) and pressure for cleaning between teeth without damage to gums.

The spray head can be mounted on the sink or on the countertop with a mounting structure on or near the sink with a relatively low footprint and a relatively low vertical profile. For example, the spray head can be inserted into a hole in the sink or counter, and the hose can connect to the sink's plumbing system below the counter. In some arrangements, mounting structures can be provided to mount the spray head at other locations near the sink, such as on the wall or at the side of a bathroom vanity. In use, the user can remove the spray head from the mounting structure, extend the hose through the hole and position the spray head near the teeth and/or gum tissue to be cleaned. The user can activate the spray head by actuating one or more control features (e.g., button(s)) on the spray head to direct the liquid to the region to be cleaned. When the user finishes cleaning the teeth and/or gums, the user can deactivate the spray head with the control feature(s) and can replace the spray head in the mounting structure on the counter or sink.

As explained herein, the fluid supply or plumbing components that supply the water the spray head may be advantageously disposed underneath the counter and hidden from view by one or more counter doors. Thus, the use of a low-profile, low-footprint spray head and hidden fluid supply components can enable the use of an aesthetically pleasing irrigation system. Furthermore, integrating the oral irrigation system with standard plumbing components of a sink can advantageously eliminate or reduce the use of additional electrical connections to the power outlets. The water supplied by the sink's water supply (which may correspond to water pressures delivered by residential water supply systems) may also be channeled to provide a stream that is narrow enough and of a suitable pressure for cleaning of teeth and/or gums. Moreover, the spray head can advantageously be mounted separately from the faucet (e.g., on the counter or on a portion of the sink spaced apart from the faucet) such that the spray head need not be attached to and detached from the faucet.

Thus, in some embodiments, an oral irrigator system may comprise suitable connectors, conduits, a spray head, and other plumbing components configured to be mounted to a countertop or standard sink, e.g., a sink in a bathroom of a house, apartment, hotel, business establishment, or other building. The connectors may be attached or connected to various pipes and tubes that are disposed below the sink. The connectors and conduits may allow the spray head to be in fluid communication with water supply lines located beneath the countertop or sink. The supply lines are connected to a water source, and the water source may include a pipe extending from a wall or floor or other section. The water supply lines often comprise copper pipes or other conduits that conduct water of various temperatures. The conduits of the oral irrigation system may also comprise a flexible hose that connects to the water supply lines. Many bathroom sinks are configured such that the user can adjust the flow and temperature of the water that comes out of the faucet by adjusting one or more knobs, levers, or handles that are usually located on the upper side of a bathroom sink, on or near the faucet. The connectors and/or other components of the oral irrigation system may comprise any of: diverters, valves, conduits, mixers, a spray head, and a nozzle.

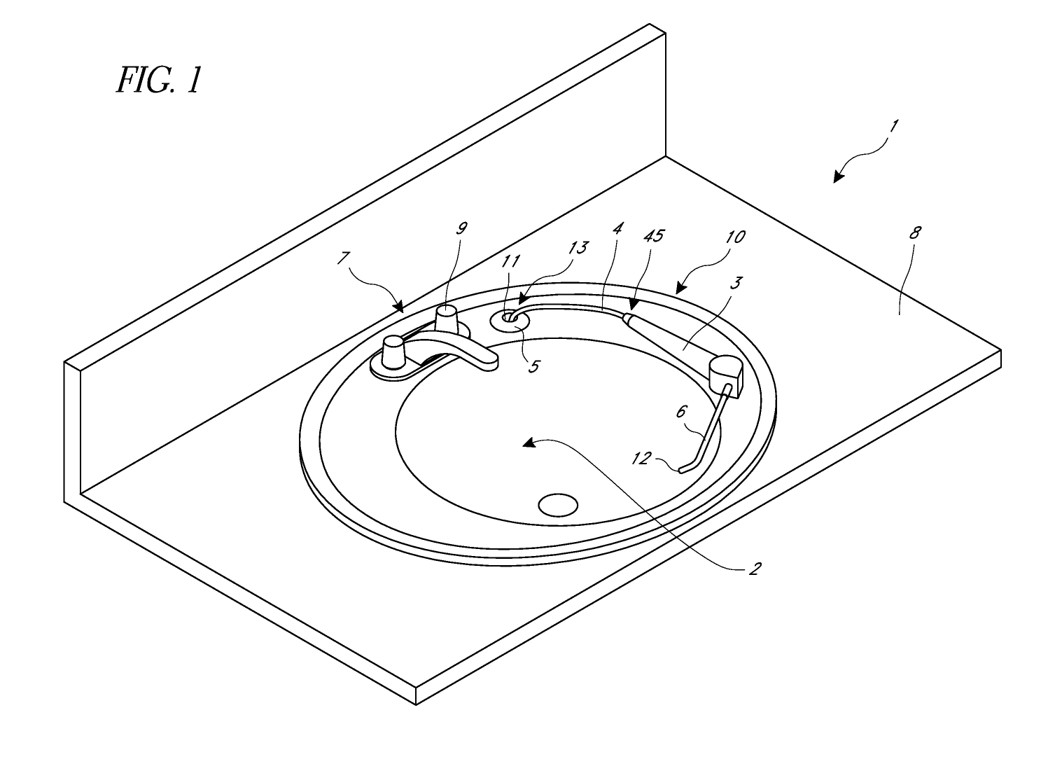

FIG. 1 is a schematic perspective view of an oral irrigation system 1 including a spray head 10 mounted to a sink 2 that is installed on a counter 8, according to one embodiment. The sink 2 can be any suitable sink, including a standard sink used in bathrooms, kitchens, or other rooms of any suitable building, such as a residence (e.g., house, apartment, etc.), hotel, place of business, etc. The sink 2 can be connected to the building's plumbing system by way of various pipes and connectors disposed under the sink 2 and counter 8. The sink 2 can include a faucet 7 that delivers water to the bowl of the sink 2. One or more knobs 9 can be provided to adjust the temperature and/or flow rate of water that is supplied to the sink 2.

The spray head 10 can include a handpiece 3 and a nozzle 6 at a distal portion of the handpiece 3. A hose 4 can couple with a proximal portion of the handpiece 3 and can provide fluid communication between the spray head 10 and the plumbing system to which the sink 2 is connected. As shown in FIG. 1, the spray head 10 can be removably mounted to a mounting structure 13 that includes a hole 11 and a flange 5 mechanically connected to the sink 2 and surrounding (or at least partially surrounding) the hole 11. Although the mounting structure 13 is shown in FIG. 1 as being mounted to the sink 2, in other embodiments, the mounting structure 13 can be mounted or attached to the counter 8 near the sink 2, or to any other structure near the sink such as a wall. Further, in some embodiments, the mounting structure 13 comprises the hole 11 formed through the sink 2 or counter 8 in cooperation with the shape of the handpiece 3, without the illustrated flange 13. For example, the hole 11 can be shaped (e.g., tapered) to allow the hose 4 to pass through freely, but not allow the spray head 10, and particularly the handpiece 3, to pass through. Instead, the hole 11 is shaped to receive and hold a proximal end of the handpiece 3. In some arrangements, the hose 4 can pass through the plunger hole of a standard sink, e.g., the hole through which the sink's plunger is disposed.

The hose 4 can extendably pass through the hole 11 in the mounting structure 13 and can fluidly couple with the plumbing system of the sink 2 which may be disposed below the sink 2 and counter 8. The handpiece 3 of the spray head 10 may be sized and shaped to fit in the hole 11 (as modified by the flange 5, if any) for storage. For example, the handpiece 3 may comprise a proximally-tapered body portion having a proximal end narrower than a distal portion of the handpiece 3. The handpiece 3 can be stored in the hole 11 of the mounting structure 13, and the user can remove the spray head 10 from the hole 11 to begin a cleaning procedure. The hose 4 may have sufficient slack or may be sufficiently flexible such that the spray head 10 can extend away from the sink 2 to reach the user's mouth without the user bending down over the sink. In some embodiments, the hose 4 can comprise a plastic material, a metal material, or any other suitable material. For example, the hose 4 can comprise a coiled plastic or metal (e.g., copper) pipe or tube. In some embodiments, the hose 4 can comprise a metal hose having multiple discrete metal segments or scales that are configured to permit the hose 4 to bend when manipulated by the user. The use of a metal for the hose 4 can advantageously add mass and/or stiffness to the hose 4, and the scaled structure can limit the degree to which the hose 4 can be bent, which can assist in retracting the hose 4 when the user completes the cleaning procedure. For example, the weight of the hose 4 can introduce a bias in the direction of the hole 11 such that when the user releases the hose 4, the hose automatically retracts into the hole 11. In some embodiments, a separate weight or slug can be added to the hose 4 above or below the counter 8 to assist in retracting the hose 4.

The handpiece 3 can be any suitable handpiece configured to output a stream of liquid in a user's mouth. By way of example, the handpiece 3 can comprise the DCI Air/Water Syringe manufactured by Kalmed Dental Products, Inc., of Marietta, Ga. The handpiece 3 can connect to the hose 4 by way of a connector 45. In some arrangements, the handpiece 3 is secured permanently or semi-permanently to the hose 4 with the connector 45 such that the handpiece 3 is not configured to be removed by the user (other than by breaking or cutting the connection between the handpiece 3 and the hose 4). In other arrangements, the connector 45 can comprise a quick-connect device configured to removably couple the handpiece 3 to the hose 4. In such arrangements, the user can attach the handpiece 3 to the hose 4 by engaging the connector and can remove the handpiece 3 by disengaging the connector 45. The connector 45 can provide both a mechanical connection and a fluid connection between the hose 4 and the handpiece 3.

The user may remove the handpiece 3 to clean the handpiece 3 or portions thereof (such as the nozzle 6). In some embodiments, the handpiece 3 may be disposable, such that the user can remove the handpiece 3 after a number of uses and dispose the handpiece 3. The user can procure a new handpiece 3 and can connect the new handpiece 3 to the hose 4 by way of the connector 45. Advantageously, the use of a quick-connect connector 45 can enable the user to maintain a sanitary environment by disposing handpieces that are unclean. In other embodiments, the handpiece 3 may not be removable from the hose 4, but the nozzle 6 can be readily removed for cleaning and/or disposal and replacement. The hose 4 can have a size (e.g., outer diameter) that is dimensioned to be received by an inlet of the handpiece 3. For example, in various embodiments, the hose 4 can have an outer diameter in a range of about 0.125 inches to about 0.5 inches, e.g., about 0.25 inches.

In operation, the user can grip the handpiece 3 with his or her hand and can position the distal end 12 of the nozzle 6 at or near the teeth or gum tissue to be cleaned. The user can activate the spray head 10 to cause liquid to flow from the sink's plumbing system, through the hose 4, and into the user's mouth by way of an outlet at the distal end 12 of the nozzle 6. The user can manipulate the spray head 10 to move from tooth to tooth and to different portions of the gums to ensure a thorough cleaning. After cleaning is complete, the user can deactivate the spray head 10 and can place the spray head 10 back on the mounting structure 13. In some embodiments, prior to using the system, the user can turn on the faucet 9 of the sink to initiate a flow of water through the plumbing system. For example, to initiate the flow of hot or warm water, the user can turn the faucet(s) to purge cold water in the pipes between the hot water heater and the sink 2, and to initiate a stream of water at a suitably warm temperature that is desirable to the user. After sufficiently warm water is coming through the faucet 9, the faucet 9 can be turned off and the user can turn on flow to the handpiece 3.

The nozzle 6 is sized relative to the water supply pipes beneath the sink 2 to produce a stream of water under sufficient pressure to allow water flossing function without risk of damage to gum tissue. In particular, the nozzle 6 can be configured to produce and convert typical household water pressure (e.g., 50 to 70 psi) to pressure in the range of about 35 psi to about 80 psi, or more particularly, in a range of about 35 psi to about 70 psi. In some arrangements, the pressure output by the nozzle 6 can be in a range of about 35 psi to about 60 psi, or about 40 psi to about 50 psi.

Thus, the system 1 shown in FIG. 1 enables the user to easily use an oral irrigation device without the use of external electrical connections or components that attach to the faucet 7. Further, the system 1 can be seamlessly integrated into the plumbing system of the sink 2, which improves the aesthetics of the sink 2 and counter 8, while also drawing water from conventional residential water systems rather than a reservoir or storage tank.

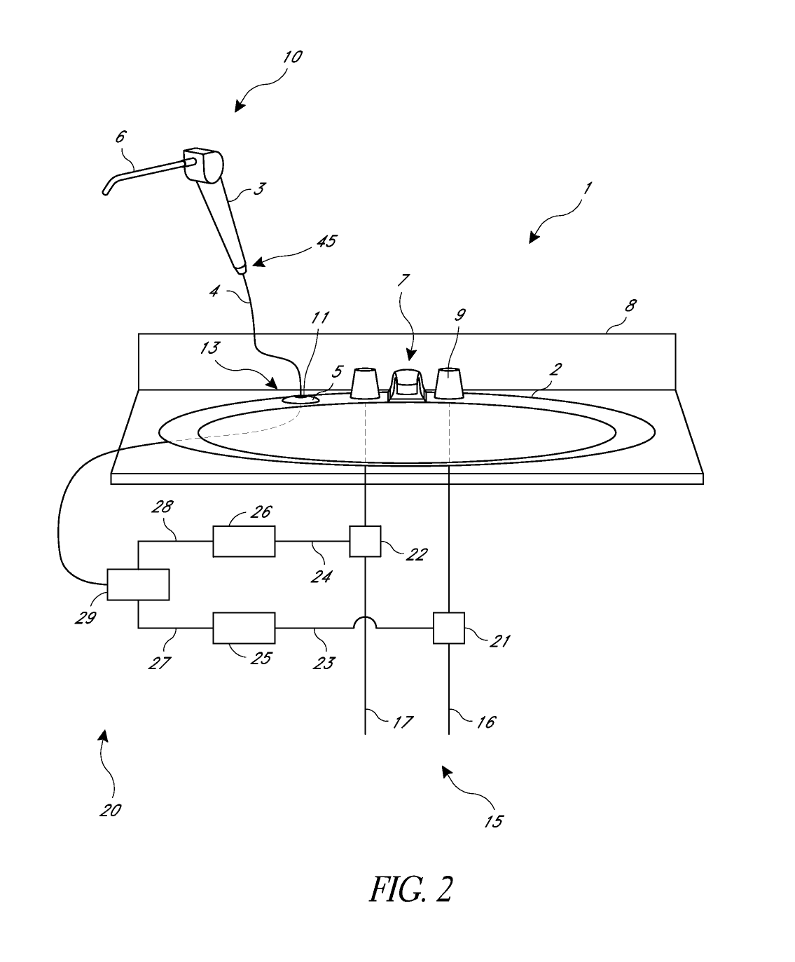

FIG. 2 is a schematic system diagram of various components of the system 1 shown in FIG. 1. As with FIG. 1, the system 1 is installed on a sink 2 or counter 8 near the sink 2. The sink 2 shown in FIG. 2 receives water supplied by a standard plumbing system 15 of the building to which the sink 2 is connected. Unless otherwise noted, in FIG. 2, components that are similar to or the same as those shown in FIG. 1 are referenced using the same reference numerals used in FIG. 1. For example, as explained above with respect to FIG. 1, the oral irrigation system 1 can include a spray head 10 and a hose 4 connected to the spray head 10. The spray head 10 can be stored on the counter 8 or sink 2 by way of the mounting structure 13, which can include the flange 5 in cooperation with the proximal end of the handpiece 3 as shown, just the handpiece and the hole 11 in the sink 2 or counter 8, or in other arrangements a bracket for holding the handpiece on the wall or vanity.

Underneath the counter 8 and sink 2, the system 1 can include an irrigator installation assembly 20 configured to mechanically and fluidly connect the system 1 to the plumbing system 15 to which the sink 2 is connected. For example, the installation assembly 20 can include various connectors, conduits, and/or other components suitable to fluidly connect the system 1 to the plumbing system 15 that supplies water to the sink 2. The installation assembly 20 can thereby enable the plumbing system 15 to supply water to both the sink 2 and the spray head 10 for cleaning the teeth and gums of the user. For example, the installation assembly 20 can include a kit comprising at least one of a first diverter 21, a second diverter 22, a first valve 25, a second valve 26, a mixer 29, a first conduit 23, a second conduit 24, a third conduit 27, and a fourth conduit 28.

As shown in FIG. 2, in some embodiments, the first diverter 21 is attached to a first water supply line 16 of the plumbing system 15. The first diverter 21 can be configured to direct a stream of water to multiple locations. For example, the first diverter 21 may be configured to allow water to continue to flow to the faucet 7, but also allow water to flow to a second location, e.g., to the spray head 10. The first valve 25 may be connected, directly or via the first conduit 23, to the first diverter 21. The first valve 25 may be configured to regulate the flow of water coming from the first water supply line 16 and through the first diverter 21. The first valve 25 may comprise a ball valve or other valve that can adequately modulate the flow rate and/or pressure of water flowing through the valve. Other valves may perform a similar function and be usable.

The first conduit 23 may connect the first diverter 21 to the first valve 25 and may comprise a copper pipe, plastic tubing, or other fluid transfer device that can adequately transmit water from the first diverter 21 to the first valve 25. The first conduit 23 may be attachable to the first diverter 21 and/or the first valve 25 using various plumbing methods which may include compression fittings and other methods of connecting components. The second diverter 22 may be attached to a second water supply line 17 of the plumbing system 15. The second valve 26 may be connected to the second diverter 22 using configurations and methods similar to those described above for the first diverter 21 and first valve 25, for example, by way of the second conduit 24.

The first and second diverters 21, 22 may be connected to the respective first and second water supply lines 16, 17 using various methods. For instance, as a non-limiting example, the diverters 21, 22 may be disposed in a section of the respective water supply line 16, 17 in the middle of a pipe or at an already existing junction. If the diverter 21 or 22 is to be attached to the water supply line 16 or 17 in the middle of a pipe, the pipe may be cut and the diverter inserted between the two pipe ends. The diverter 21 or 22 may also be attached at an already existing junction. For instance, as a non-limiting example, the diverter 21 or 22 may be inserted between a flexible hose and the faucet pipe (which may be already connected to the faucet). In order to attach the diverters 21, 22, one may remove the water supply line 16, 17 from the faucet pipe and insert the diverter 21, 22. In some cases, the diverters 21, 22 may not utilize additional adapters and may be attached directly to the adapters already present. This process may be performed for both the first and second water supply lines 16, 17.

With continued reference to FIG. 2, in some embodiments, the mixer 29 may be in fluid communication with the first valve 25 and the second valve 26. The mixer 29 may be connected to the valves 25, 26 directly, or a conduit may be disposed between the mixer 29 and one or more of the valves. For example, as shown in FIG. 2, the third conduit 27 provides fluid communication between the first valve 25 and the mixer 29. The fourth conduit 28 provides fluid communication between the second valve 26 and the mixer 29. The conduits 27, 28 may be similar to the conduits 23, 24 disposed between the first diverter 21 and first valve 25 and between the second diverter 22 and second valve 26. The mixer 29 may be configured to allow water from the first valve 25 and second valve 26 to be combined into a single lumen of the hose 4, which can connect to the mixer 29.

In some embodiments, the first water supply line 16 comprises a cold water supply line and the second water supply line 17 comprises a hot water supply line. In these embodiments, the first valve 25 may regulate the amount, pressure, and/or flow rate of cold water supplied to the mixer 29, and the second valve 26 may regulate the amount, pressure, and/or flow rate of hot water supplied to the mixer 29. In these embodiments, the mixer 29 may merge cold and hot water from the first and second water supply lines 16, 17, respectively, resulting in water output that has a temperature that is in between that of the cold water and hot water supplied to the first and second diverters 21, 22. Thus, adjusting the first and second valves 25, 26 may allow a user to regulate the temperature of the water being discharged from the mixer 29 and supplied to the spray head 10 by way of the hose 4.

The mixer 29 may be connected to the spray head 10 that is positioned above the surface of the counter 8, directly or indirectly. For instance, the hose 4 is shown to fluidly connect the output of the mixer 29 with an inlet of the spray head 10, which may be disposed at or near a proximal portion of the handpiece 3. The hose 4 may comprise a generally flexible tubing, such as plastic or vinyl tubing, or other material that is suitable to carry water to a user. The hose 4 may be several inches long, and may be as long as several feet, or longer. However, the hose 4 may only be long enough to connect the mixer 29 to the spray head 10, and allow a user to move the spray head 10. In some embodiments, the hose 4 may be 1-4 feet long, for example 2-3 feet long, and may be long enough to allow the user to pick the spray head 10 up from the counter 8 and bring the spray head 10 to the user's mouth, while over or near the sink 2. The hose 4 may attach to the mixer 29 and/or the spray head 10 using various attachment methods, such as a compression fitting or sliding the hose 4 over a barb. Other methods of attachment may be suitable as well.

The hose 4 connecting the mixer 29 to the spray head 10 may be disposed in the hole 11 in the counter 8 or sink 2, as shown in FIG. 2. Thus, the hose 4 may extend from the mixer 29 disposed beneath the sink 2, up through the hole 11, to the spray head 10, which is generally used above or near the sink 2. In some embodiments, the hole 11 (as modified by any flange 5) may be large enough to allow the hose 4 to move freely through the hole 11, but not large enough for the handpiece 3 of the spray head 10 to travel through the hole 11. This may be advantageous to the user because after he or she is finished using the spray head 10 and oral irrigation system 1, he or she may return the spray head 10 to the hole 11 and flange 5, which may be configured to house the spray head 10 when it is not in use. This may be a convenient place for the spray head 10 to reside between uses as it is available for use, but out of the way of other sink-related activities.

In some embodiments, a weight may be attached to part of the hose 4 extending from the mixer 29 to the spray head 10. The weight may be placed such that when the user is finished using the spray head 10 and oral irrigation system 1, and places the spray head 10 into its resting position on the mounting structure 13, the hose 4 may be drawn back through the hole 11. Securely locating the hose 4 beneath the counter 8 may prevent the hose 4 from becoming tangled above the counter 8. As noted above, the hose 4 may include a segmented metal cladding that can obviate the separate weight and also stiffen the hose 4 to facilitate retraction.

In some embodiments, a flow regulator (not shown) may be located downstream of the mixer 29, e.g., between the mixer 29 and the spray head 10. The flow regulator may be configured to regulate the amount, flow rate, and/or pressure of the water that is released by the spray head 10. It may be advantageous for a user to have a flow regulator disposed downstream of the mixer 29, so that the user may regulate the flow of water released by the spray head 10, but not alter the temperature of the water delivered to the spray head 10.

In some embodiments, a one-way valve, or check valve, may be located within the oral irrigation system 1. For instance, as a non-limiting example, a first one-way valve (not shown) may be disposed between the first diverter 21 and the mixer 29. The first one-way valve may prevent water flowing from the second diverter 22 to the mixer 29 from traveling back through the first diverter 21 and first water supply line 16. This may be advantageous if the pressure of one water supply line is different from the pressure of the other water supply line. In some embodiments, a one-way valve may be disposed between the first diverter 21 and mixer 29, and also between the second diverter 22 and mixer 29.

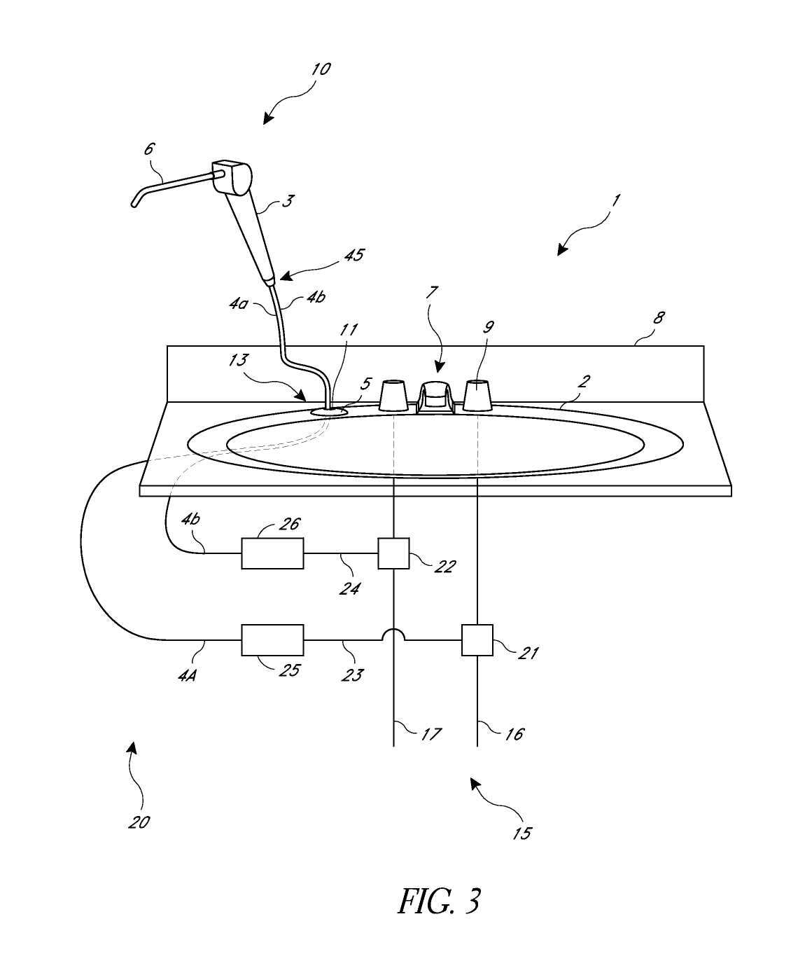

FIG. 3 is a schematic system diagram of the system 1 shown in FIG. 1, according to another embodiment. The system 1 of FIG. 3 is similar to the system shown in FIG. 2. For example, as with the embodiment of FIG. 2, the system 1 shown in FIG. 3 includes an irrigator installation assembly 20 configured to connect to a standard plumbing system 15, a spray head 10 in fluid communication with the installation assembly 20, and a mounting structure 13 to mount the spray head 10 to the sink 2 or counter 8 Like the installation assembly 20 of FIG. 2, the installation assembly 20 of FIG. 3 can include a first diverter 21, a second diverter 22, a first conduit 23, a second conduit 24, a first valve 25, and a second valve 26.

However, the embodiment of FIG. 3 does not include a mixer below the sink 2 to mix the two streams of water prior to delivering the water to the spray head 10. Rather, as shown in FIG. 3, the system 1 can include a first hose 4a to convey water from the first valve 25 to the spray head 10 and a second hose 4b to convey water from the second valve 26 to the spray head 10. Thus, if the first supply line 16 carries cold water, then the first hose 4a can convey the cold water supplied by the plumbing system 15 to the spray head 10. If the second supply line 17 carries hot water, then the second hose 4b can convey the hot water supplied by the plumbing system 15 to the spray head 10. A regulator or mixer in the spray head 10 may combine the hot and cold water streams within the spray head 10 in some embodiments. It should be appreciated that the two hoses 4a, 4b can be bundled together within a single conduit or hose or metal cladding (not shown) to prevent the two hoses 4a, 4b from becoming tangled and to facilitate withdrawal and retraction through the hole 11.

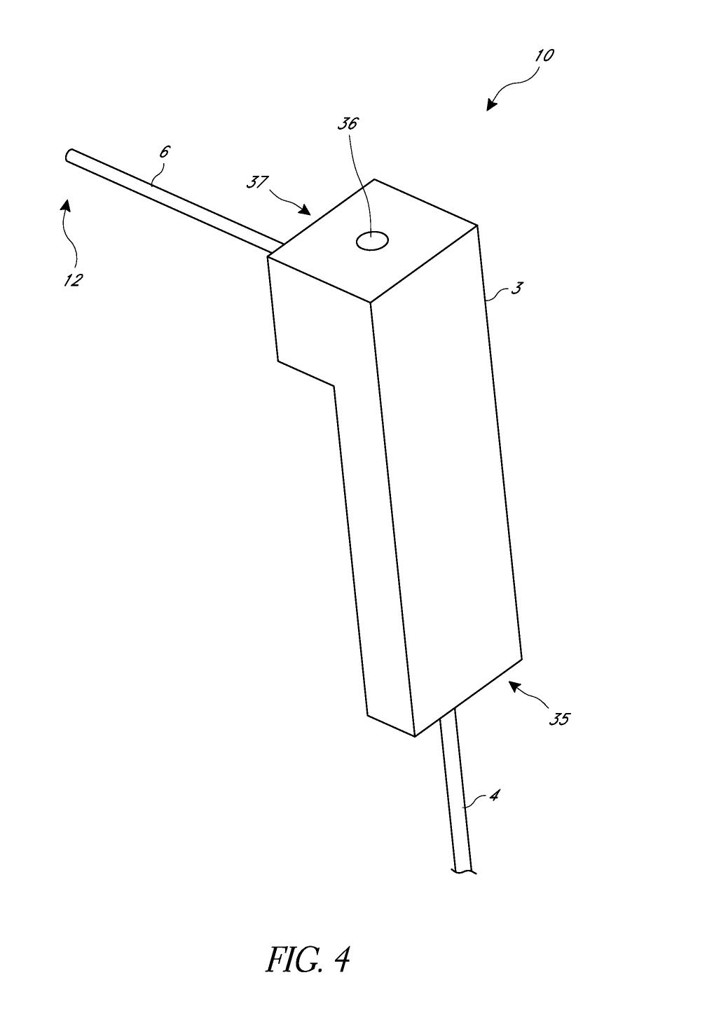

FIG. 4 is a schematic perspective view of a spray head 10, according to one embodiment. As shown in FIG. 4, the spray head 10 may comprise a handpiece 3 and at least one nozzle 6 extending from a distal portion of the handpiece 3. In some embodiments, the handpiece 3 may be configured such that it can be held in the user's hand. The handpiece 3 may comprise an inlet 35, a single selector 36, and an outlet 37 that may be connected to the nozzle 6. One end of the hose 4 can be attached to the outlet of the mixer 29 shown in the embodiment of FIG. 2. The opposite end of the hose 4 may be attached to the inlet 35 of the spray head 10, such that the combined stream of water exiting the mixer 29 enters the spray head 10 through the hose 4 and the inlet 35. The spray head 10 may be configured such that when the selector 36 is depressed or activated, water travels through the spray head 10 from the inlet 35 through the outlet 37 of the handpiece 3, and exits the spray head 10 through a distal end of the nozzle 6. In some embodiments, the user can depress and hold the selector 36 down to cause liquid to exit the spray head 10 and can release the selector 36 to stop the flow of liquid from the spray head 10. In such an arrangement, the flow cannot continue without the user holding the handpiece 3 and continually depressing the selector 36, to prevent spray from continuing if the user inadvertently drops or puts down the handpiece 3. In other embodiments, the user can click (e.g., press and release) the selector 36 in a first instance to activate the spray head 10 to cause liquid to flow and can click the selector 36 in a second instance to deactivate the spray head 10 to stop the flow of liquid. In some embodiments, the spray head 10 can include a safety device to enable activation by only an authorized user, e.g., to prevent young children from accidentally activating the spray head 10.

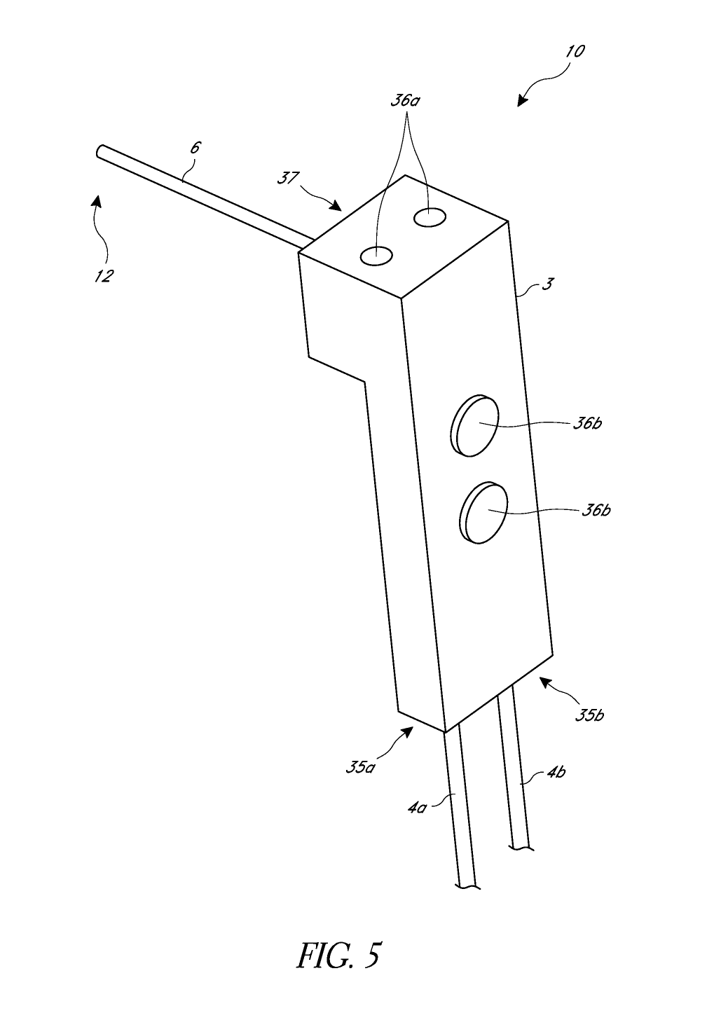

In some embodiments (see FIG. 5), the spray head may comprise more than one selector 36 and/or a flow regulator within the handpiece 3. The inlet 35 may be disposed at the base or proximal portion of the handpiece 3, and may be configured to accept the hose 4 or other fluid transfer device. The hose 4 may convey water from the mixer 29 to the spray head 10. The selector 36 may be configured to regulate the flow of water from the inlet 35 of the spray head 10 to the nozzle 6. The selector 36 may be configured to allow all of the water to flow to the nozzle 6, none of the water to flow to the nozzle 6, or an intermediate flow of water to flow to the nozzle 6. In some embodiments, the selector 36 may be configured such that the user may regulate the flow of water to reduce or increase the flow of water through the spray head 10 during the cleaning procedure. The spray head 10 may comprise commercially available air or water syringes in various embodiments, such as the DCI™ Air/Water Syringe manufactured by Kalmed Dental Products, Inc., of Marietta, Ga.

FIG. 5 is a schematic perspective view of a spray head 10 having multiple inlets, according to another embodiment. The spray head 10 can be configured to fluidly connect to the installation assembly 20 shown in FIG. 3, in which there is no mixer to mix the hot and cold water streams prior to delivery to the spray head 10. As shown in FIG. 5, in some embodiments, the spray head 10 may comprise a first inlet 35a and a second inlet 35b. The first inlet 35a can be configured to accept water from a cold water supply line, and the second inlet 35b can be configured to accept water from a hot water supply line. For example, as shown in FIG. 3 above the first diverter 21 from the first water supply line 16 may be connected to the first inlet 35a of the spray head 10, and the second diverter 22 from the second water supply line 17 may be connected to the second inlet 35b of the spray head 10. Also, as shown in FIG. 3, first and second valves 25 may be disposed between the first and second diverters 21, 22 and first and second hoses 4a, 4b, although such valves may be omitted. Thus, first hose 4a can convey liquid from the first supply line 16 to the spray head 10, and the second hose 4b can convey liquid from the second supply line 17 to the spray head 10.

In the embodiment of FIG. 5, the spray head 10 may comprise one or more flow regulators or valves, such that the user may be able to adjust the water pressure and/or flow rate at the nozzle 6, as well as the temperature of the water delivered by the nozzle 6. For example, as shown in FIG. 5, a first set of one or more selectors 36a can be provided to turn flow to the nozzle 6 on or off, or to adjust the flow rate or pressure of the water, and a second set of one or more selectors 36b can be provided to adjust the temperature of the water delivered to the nozzle 6. Advantageously, the user can adjust both the temperature of the water and the flow rate and/or pressure of the water delivered to the mouth.

In some embodiments, the spray head may comprise two inlets, in which the first inlet 35a is configured to accept water from the plumbing system 15 (e.g., by way of the mixer 29 of FIG. 2 or from a conduit in communication with a hot or cold supply line), and the second inlet 35b is configured to accept compressed air. The compressed air may be delivered from a stored compressed air source, such as a cartridge or tank, or the compressed air may be delivered from a mechanical air compressor. In these embodiments, the second set of selectors 36b can allow the user to select to have water be discharged from the nozzle, or have air be discharged from the nozzle.

In other embodiments, the first inlet 35a can receive water from the plumbing system 15, and the second inlet 35b can receive a treatment fluid configured to assist with the cleaning procedure. For example, a reservoir can be provided under the counter 8. The reservoir can be filled with a suitable treatment fluid, such as mouthwash, an alcohol-based liquid, a fluorine-based liquid, or any other suitable treatment chemical. The additional treatment fluid can be used in conjunction with, or instead of, water to help clean the teeth and/or gums. In some procedures, the user can activate the spray head 10 to simultaneously deliver water and the treatment fluid. In other procedures, the user can activate the spray head 10 to sequentially or alternately deliver water and the treatment fluid. For example, the user can deliver water to irrigate the mouth of debris, toothpaste, or other materials, and can subsequently deliver the treatment fluid (such as mouthwash) to the mouth to further clean the mouth. After supplying the treatment fluid, the user can again supply water to rinse the mouth of the treatment fluid. In some embodiments, a separate pump can be used to pressurize and deliver the treatment fluid to the spray head 10. In other embodiments, one of the water supply lines can be connected to the reservoir to drive the treatment fluid from the reservoir using the water pressure.

In some embodiments, the spray head 10 comprises a metal material, such as stainless steel or a plastic that is suitable for household use. The spray head 10 may comprise other materials as well. The spray head may comprise different colors, textures, or sizes, depending on user preference. In some embodiments, the nozzle 6 may be disconnected from the spray head 10. The oral irrigation system 1 may comprise more than one nozzle 6, and may be configured to allow each member of a family to use a separate nozzle 6. Thus, a first user may attach a first nozzle to the spray head for use, and a second user may disconnect the first nozzle, and connect a second nozzle to the spray head. In some embodiments, each nozzle of an oral irrigation system may comprise a marker or indicator, such that a first nozzle may be distinguishable from a second nozzle. The marker or indicator may comprise a different color, texture, pattern, of at least part of the nozzle. The removability of the nozzle 6 from the spray head 10 may also enable the user to clean the nozzle after use. Multiple nozzles can also be provided with different opening sizes to represent different outlet pressures, stream sizes and flow rates from which the user can choose, depending upon sensitivity, for example. In other arrangements, the nozzle 6 may be disposable, such that the user can discard and replace the nozzle 6 after one or more treatment procedures for better hygiene.

To use the oral irrigation system, the user may adjust the first and second valves 25, 26 of the installation assembly 20 as desired to adjust the temperature, flow rate, and/or water pressure of the water exiting the nozzle 6. The user may readjust the first and second valves 25, 26 at a later time if the temperature and/or water pressure of the water exiting the nozzle 6 is not as desired. The user may pick up the spray head 10, insert at least part of the nozzle 6 into or near the user's mouth, and then press or otherwise engage a selector 36 on the spray head 10. Upon activation, water is discharged from the nozzle, and the user may direct the discharged water to various portions of the user's mouth. The user may desire to direct the water at the gums and/or the spaces between teeth, or other portions of the mouth. Use of an oral irrigation system may be beneficial to the user, as it may improve his or her dental hygiene and overall dental health.

The water pressure of the water discharged by conventional, electrically-powered oral irrigators may be around 60 pounds per square inch (“psi”). The pressure of the water emitted by the nozzle 60 of the systems 1 disclosed herein may at least partially depend on the pressure of the water supply lines 16, 17, and the water pressure of the plumbing system 15 of the building. For example, the average pressure of water in a residential house may generally be around 50-70 psi. Therefore, by selection of flow allowed by the valves 25, 26 and/or selectors 36, 36a, 36b, the pressure of water produced by the oral irrigation system 1 may be selected to be in ranges comparable to that produced by conventional, powered devices. For example, the pressure of the water at the outlet of the spray head 10, inlet 35 of the spray head 10, between the spray head 10 and the mixer 29, or at other locations along the system 1 may generally be around 60 psi. In various arrangements, the pressure of the water delivered by the system 1 may be in a range of about 35 psi to about 80 psi, or more particularly, in a range of about 35 psi to about 70 psi. In some arrangements, the pressure output by the nozzle 6 can be in a range of about 35 psi to about 60 psi, or about 40 psi to about 50 psi.

In some embodiments, the water exiting the nozzle 6 of the spray head 10 may comprise a transverse dimension along a direction transverse to the direction along which water flows. The transverse dimension may comprise a diameter or other dimension measured from one side of the water stream to the other side. The transverse dimension of the water stream may be less than about 5 mm, less than about 3 mm, or less than about 1.5 mm. In some embodiments, the transverse dimension of the water stream may be in a range of about 0.5 mm to about 5 mm, or in a range of about 1.5 mm to about 3 mm. The transverse dimension of the water stream may be measured at the point it exits the nozzle 6, near the point the stream exits the nozzle 6.

The oral irrigation systems 1 described herein may be advantageous over other oral irrigation systems currently available. For instance, as a non-limiting example, other systems require electricity and comprise motors and other moving parts; they are also designed to sit upon the countertop, which often takes up valuable space. The oral irrigation systems 1 disclosed herein need not be powered by electricity, and are therefore usable even if the power goes out. The oral irrigation system also need not comprise a motor or similar moving parts, and therefore comprises fewer pieces that may break or degrade in quality.

Some oral irrigation systems on the market are temporarily attachable to a sink faucet. These systems generally attach to the output of the faucet at or near the aerator, and redirect the water through a spray head and nozzle. However, these systems require the user to recalibrate the water pressure and water temperature for each use. Furthermore, the user may need to attach and detach at least part of the system to the faucet for each use. This is not only time consuming, but the user also runs the risk that the system is not adequately sealed to the faucet, resulting in water spraying from the connection. This problem is exacerbated by the fact that the system is connected and disconnected with each use. The oral irrigation systems 1 disclosed herein, which are attached to the plumbing system beneath the sink, allows the user to set the system up once without having to periodically attach and detach any connectors. Furthermore, the oral irrigation system 1 may allow the user to calibrate the water temperature and water pressure once without having to frequently readjust the valves.

Other cleaning devices attach to a portion of the user's showerhead and/or shower plumbing system. However, these products are limited to use in the shower while the shower is running, which may limit the convenience and/or desirability of the device. The oral irrigation system 1 disclosed herein, which is connected to the plumbing of the sink, may be more versatile and more usable by the user, since the user may be able to use the system more often than he or she uses the shower. For example, the user may desire to quickly use the oral irrigation system 1 after a meal. The oral irrigation system 1 may allow the user to quickly and easily use the system multiple times per day with little to no set up.

### Terminology; Additional Embodiments

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “above” or “below” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations may be described in a particular order, this should not be understood as requiring that such operations be performed in the particular order described or in sequential order, or that all illustrated operations be performed, to achieve desirable results. However, other operations that are not described can be incorporated in the example processes that are described. Additionally, other implementations are within the scope of the following claims. In some cases, the actions recited in the claims can be performed in a different order and still achieve desirable results.

In describing the present technology, the following terminology may have been used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims that follow.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Conjunctions, such as “and,” “or” are used interchangeably and are intended to encompass any one element, combination, or entirety of elements to which the conjunction refers.

What is claimed is:

1. An oral irrigation system comprising:
a spray head comprising a nozzle configured to generate a stream of liquid to clean the teeth or gum tissue of a user, the spray head configured to mount to a sink or to a structure near the sink;
an installation assembly configured to mechanically and fluidly connect to a plumbing system of a building, the plumbing system supplying water to the sink by way of a first water supply line, the installation assembly configured to direct a portion of the water from the first water supply line to the spray head; and
a hose to provide fluid communication between the spray head and the installation assembly.

2. The oral irrigation system of claim 1, further comprising a mounting structure configured to mount the spray head to a sink or adjacent the sink to a counter to which the sink is mounted.

3. The oral irrigation system of claim 2, wherein the mounting structure comprises a flange to be disposed about a hole through the sink or the counter, and wherein the hose passes through the hole when the hose is connected to the spray head and the installation assembly.

4. The oral irrigation system of claim 3, wherein the hose is retractable through the hole when the hose is connected to the spray head and the installation assembly.

5. The oral irrigation system of claim 1, wherein the installation assembly includes a kit comprising at least one of a diverter configured to direct a stream of liquid to at least two locations, a valve to regulate the flow of the stream of liquid, a mixer configured to mix two or more streams of liquid, and a conduit to convey the stream of liquid.

6. The oral irrigation system of claim 5, wherein the kit comprises a first diverter configured to couple to the first water supply line, the first diverter configured to supply water to a faucet of the sink and to the spray head.

7. The oral irrigation system of claim 6, wherein the kit further comprises a first valve configured to be disposed downstream of and in fluid communication with the first diverter, the first valve configured to regulate the flow of water to the spray head.

8. The oral irrigation system of claim 7, wherein the kit further comprises a first conduit to convey water between the first diverter and the first valve.

9. The oral irrigation system of claim 6, wherein the kit further comprises a second diverter configured to couple to a second water supply line of the plumbing system, the second diverter configured to supply water to the faucet of the sink and to the spray head.

10. The oral irrigation system of claim 9, wherein the spray head comprises a first inlet to be in fluid communication with the first water supply line and a second inlet to be in fluid communication with the second water supply line.

11. The oral irrigation system of claim 9, further comprising a mixer configured to mix a first stream of water supplied by the first water supply line with a second stream of water supplied by the second water supply line.

12. The oral irrigation system of claim 1, wherein the spray head comprises one or more selectors configured to control the flow of water through the nozzle.

13. The oral irrigation system of claim 1, wherein the spray head comprises one or more selectors configured to control the temperature of water flowing through the nozzle.

14. The oral irrigation system of claim 1, wherein a transverse dimension of the water discharged through the nozzle is in a range of about 0.5 mm to about 5 mm.

15. The oral irrigation system of claim 14, wherein the transverse dimension of the water discharged through the nozzle is in a range of about 1.5 mm to about 3 mm.

16. The oral irrigation system of claim 1, wherein the system is configured to generate the stream with a pressure in a range of about 35 psi to about 80 psi.

17. The oral irrigation system of claim 1, further comprising the sink with a hole sized to allow the hose to pass through but prevent a handpiece of the spray head from passing through.

18. A method for providing a stream suitable for oral irrigation from a building water supply, the method:
providing a spray head comprising a nozzle comprising configured to generate a stream of liquid to clean the teeth or gum tissue of a user;
mechanically and fluidly connecting an installation assembly to a first water supply line of a plumbing system of a building, the first water supply line supplying water to the sink, the installation assembly configured to direct a portion of the water from the first water supply line to the spray head; and
providing fluid communication between the spray head and the installation assembly.

19. The method of claim 18, wherein providing fluid communication comprises disposing a hose between the spray head and the installation assembly.

20. The method of claim 18, further comprising installing a mounting structure to a sink or adjacent the sink to a counter to which the sink is mounted, the mounting structure configured to mount the spray head to the sink or the counter.

21. The method of claim 20, wherein installing the mounting structure comprises forming a hole through the sink or the counter, the method further comprising passing the hose through the hole.

22. The method of claim 18, further comprising positioning the spray head near the tooth or the gum tissue and activating the spray head to direct a stream of water to the tooth or the gum tissue.

23. An oral irrigation system comprising:
a spray head comprising a nozzle configured to generate a stream of liquid to clean the teeth or gum tissue of a user;
a hole through a sink or a structure near the sink, the hole sized and shaped to receive a portion of the spray head;
an installation assembly connected to a plumbing system of a building, the plumbing system supplying water to the sink by way of a first water supply line, the installation assembly configured to direct a portion of the water from the first water supply line to the spray head; and
a hose providing fluid communication between the spray head and the installation assembly, the hose passing through the hole of the mounting structure.

24. The oral irrigation system of claim 23, wherein the hose is retractable through the hole.

25. The oral irrigation system of claim 23, further comprising a first diverter connected to the first water supply line, the first diverter to supply water to a faucet of the sink and to the spray head.

26. The oral irrigation system of claim 25, further comprising a first valve disposed downstream of and in fluid communication with the first diverter, the first valve to regulate the flow of water to the spray head.

27. The oral irrigation system of claim 26, further comprising a first conduit to convey water between the first diverter and the first valve.

28. The oral irrigation system of claim 25, further comprising a second diverter connected to a second water supply line of the plumbing system, the second diverter to supply water to the faucet and to the spray head.

29. The oral irrigation system of claim 28, wherein the spray head comprises a first inlet in fluid communication with the first water supply line and a second inlet in fluid communication with the second water supply line.

30. The oral irrigation system of claim 28, further comprising a mixer to mix a first stream of water supplied by the first water supply line with a second stream of water supplied by the second water supply line.

31. The oral irrigation system of claim 23, further comprising a mounting structure mounted to the sink or adjacent the sink to a counter to which the sink is mounted.

32. The oral irrigation system of claim 23, further comprising the sink with a hole sized to allow the hose to pass through but prevent a handpiece of the spray head from passing through.
